(19) United States
(12) Patent Application Publication
(10) Pub. No.: US 2014/0254688 A1
(43) Pub. Date: Sep. 11, 2014

(54) Perceptual Quality Of Content In Video Collaboration

(71) Applicant: CISCO TECHNOLOGY, INC., San Jose, CA (US)

(72) Inventors: Dihong Tian, San Jose, CA (US); Jennifer Sha, Mountain View, CA (US)

(73) Assignee: CISCO TECHNOLOGY, INC., San Jose, CA (US)

(21) Appl. No.: 13/790,315

(22) Filed: Mar. 8, 2013

(51) Int. Cl. H04N 7/26

(52) U.S. Cl. CPC H04N 19/00533
USPC 375/240.25

(57) ABSTRACT

Techniques are provided for receiving and decoding a sequence of video frames at a computing device, and analyzing a current video frame N to determine whether to skip or render the current video frame N for display by the computing device. The analyzing includes generating color histograms of the current video frame N and one or more previous video frames, determining a difference value representing a difference between the current video frame N and a previous video frame N−K, where K>0, the difference value being based upon the generated color histograms, in response to the difference value not exceeding a threshold value, rendering the current video frame N or a recently rendered video frame N−K using the current video frame, and in response to the difference value exceeding the threshold value, skipping the current video frame N from being rendered.

### TECHNICAL FIELD

The present disclosure relates to sharing of content within a video collaboration session, such as an online meeting.

### BACKGROUND

Desktop sharing or the sharing of other types of content has become an important feature in video collaboration sessions, such as telepresence sessions or online web meetings. When a participant within a video collaboration session desires to share content, the content is captured as video frames at a certain rate, encoded into a data stream, and transmitted to remote users over a network connection established for the video collaboration session. Unlike natural video, which has smooth transitions (e.g., motion) between consecutive frames, user presented content may have abrupt scene changes and rapid transitions over certain time periods within the session (e.g., a rapid switch from displaying one document to another document) while also remaining nearly static at other times (e.g., staying at one page of a document or one view of other content). Because video frames are encoded under a constant bit rate (CBR), such characteristics result in large variations of quality in the decoded frames. Under the same bit rate, video frames captured during abrupt scene changes and rapid transitions are generally encoded at lower quality than frames captured from a nearly static scene. Such quality fluctuation may become fairly visible to a viewer of the presented content.

This situation can become worse when network losses are present. In a multi-point meeting, for instance, a receiving endpoint experiencing network losses may request repairing video frames, e.g., Intra-coded (I) frames, from the sending endpoint. Due to the nature of predictive coding, such repairing frames and their immediate following frames will be encoded at lower quality under the constrained bit rate, causing more frequent and severe quality fluctuation to be seen by all the receiving endpoints.

Furthermore, in many situations, due to network constraints, content is captured and encoded at a relatively low frame rate (e.g., 5 frames per second) compared to natural video that usually plays back at 30 frames per second. At a low frame rate, the quality degradations and fluctuations caused by scene changes and transitions and recursive repair frames become even more perceivable.

From a user's perspective, many transitional frames may convey little or no semantic information for the collaboration session. It may be more desirable to skip such transitional frames when they are in low quality, or frames that are corrupted due to network losses, while “locking” onto a high quality frame as soon as it appears. From that point on, if content remains unchanged, the following frames can be used to reduce any noise present in the rendered frame and further improve the quality of the rendered frame. Similarly, a receiving endpoint may also choose to skip a repair video frame, e.g., an I-frame, which was not requested by the particular receiving endpoint, and the immediately following frames that are not in sufficient quality due to predictive coding.

### BRIEF DESCRIPTION OF THE DRAWINGS

FIG. 1 is a schematic block diagram of an example system in which computing devices are connected to facilitate a collaboration session between the devices including desktop sharing from one device to one or more other devices.

FIG. 2 is a schematic block diagram of an example computing device configured to engage in desktop sharing with other devices utilizing the system of FIG. 1.

FIG. 3 is a flow chart that depicts an example process for performing a collaboration session between computing devices in accordance with embodiments described herein.

FIGS. 4-6 are flow charts depicting an example process for selecting frames to render based upon frames that are decoded utilizing the process of FIG. 3.

### DESCRIPTION OF EXAMPLE EMBODIMENTS

### Overview

Techniques are described herein for receiving and decoding a sequence of video frames at a computing device, and analyzing a current video frame N to determine whether to skip or render the current video frame N for display by the computing device. The analyzing comprises generating color histograms of the current video frame N and one or more previous video frames, determining a difference value representing a difference between the current video frame N and a previous video frame N−K, where K>0, the difference value being based upon the generated color histograms, in response to the difference value not exceeding a threshold value, rendering the current video frame N or a recently rendered video frame N−K using the current video frame, and in response to the difference value exceeding the threshold value, skipping the current video frame N from being rendered.

### EXAMPLE EMBODIMENTS

Techniques are described herein for improving the quality of content displayed by an endpoint in video collaboration sessions, such as online video conferencing. Video frames received at an endpoint during a video collaboration session are decoded and a decision to process such decoded video frames is made based upon a determined content and quality of the video frames. This allows the selective rendering (i.e., generating images for display) of frames that contain new content and are at a sufficient quality level, and also refining or updating rendered frames using information from later frames. The techniques utilize color histograms to measure differences between video frames relating to both content and quality. In one example embodiment, techniques are provided that utilize two color histogram metrics to measure frame differences based upon different causes (video content change or video quality change).

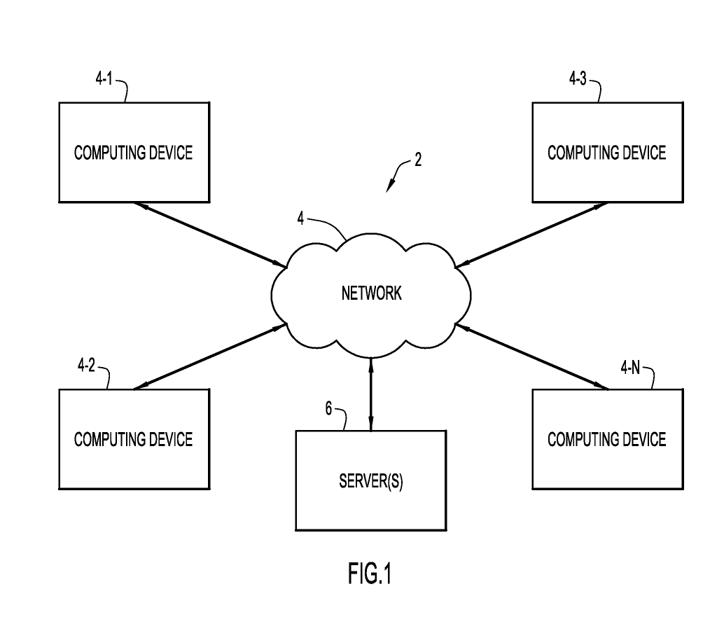

An example system that facilitates collaboration sessions between two or more computing devices is depicted in the block diagram of FIG. 1. The collaborations session can include desktop sharing of digital content displayed by one computing device to other computing devices of the system. A collaboration session can be any suitable communication session (e.g., video conferencing, a telepresence meeting, a remote log-in and control of one computing device by another computing device, etc.) in which audio, video, document, screen image and/or any other type of content is shared between two or more computing devices. The shared content can include desktop sharing, in which a computing device shares its desktop content (e.g., open documents, video content, images and/or any other content that is currently displayed by the computing device sharing the content) with other computing devices in a real-time collaboration session. The sharing of content in the collaboration session can be static (e.g., when the content does not change, such as when a document remains on the same page for some time) or changing at certain times (e.g., when switching from one page to another in a shared document, when switching documents, when switching between two or more computing devices that are sharing content during the collaboration session, etc.).

The system 2 includes a communication network that facilitates communication and exchange of data and other information between any selected number N of computing devices 4 (e.g., computing device 4-1, computing device 4-2, computing device 4-3 . . . computing device 4-N) and one or more server device(s) 6. The communication network can be any suitable network that facilitates transmission of audio, video and other content (e.g., in data streams) between two or more devices connected with the system network. Examples of types of networks that can be utilized include, without limitation, local or wide area networks, Internet Protocol (IP) networks such as intranet or internet networks, telephone networks (e.g., public switched telephone networks), wireless or mobile phone or cellular networks, and any suitable combinations thereof. Any suitable number N of computing devices 4 and server devices 6 can be connected within the network of system 2 (e.g., two or more computing devices can communicate via a single server device or any two or more server devices). While the embodiment of FIG. 1 is described in the context of a client/server system, it is noted that content sharing and screen encoding utilizing the techniques described herein are not limited to client/server systems but instead are applicable to any content sharing that can occur between two computing devices (e.g., content sharing directly between two computing devices).

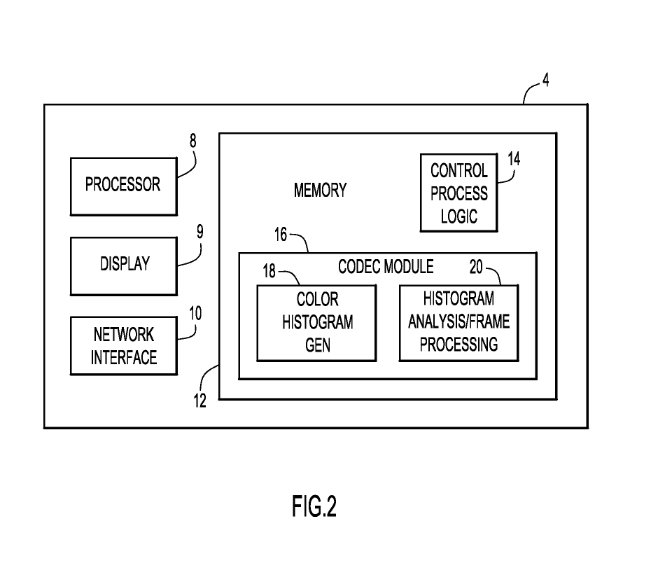

A block diagram is depicted in FIG. 2 of an example computing device 4. The device 4 includes a processor 8, a display 9, a network interface unit 10, and memory 12. The network interface unit 10 can be, for example, an Ethernet interface card or switch, a modem, a router or any other suitable hardware device that facilitates a wireless and/or hardwire connection with the system network, where the network interface unit can be integrated within the device or a peripheral that connects with the device. The processor 8 is a microprocessor or microcontroller that executes control process logic instructions 14 (e.g., operational instructions and/or downloadable or other software applications stored in memory 12). The display 9 is any suitable display device (e.g., LCD) associated with the computing device 4 to display video/image content, including desktop sharing content and other content associated with an ongoing collaboration session in which the computing device 4 is engaged.

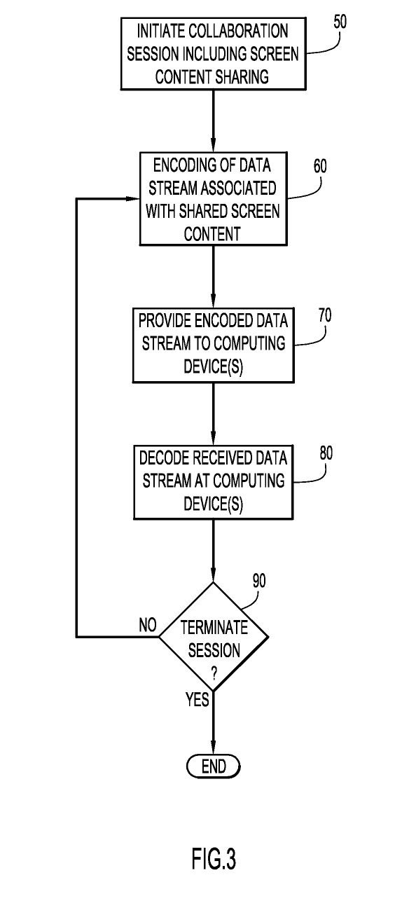

The memory 12 can include random access memory (RAM) or a combination of RAM and read only memory (ROM), magnetic disk storage media devices, optical storage media devices, flash memory devices, electrical, optical, or other physical/tangible memory storage devices. The processor 8 executes the control process logic instructions 14 stored in memory 12 for controlling each device 4, including the performance of operations as set forth in the flowcharts of FIGS. 3-6. In general, the memory 12 may comprise one or more tangible computer readable storage media (e.g., a memory device) encoded with software comprising computer executable instructions and when the software is executed (by the processor 8) it is operable to perform the operations described herein in connection with control process logic instructions 14. In addition, memory 12 includes an encoder/decoder or codec module 16 (e.g., including a hybrid video encoder) that is configured to encode or decode video and/or other data streams in relation to collaboration sessions including desktop or other content sharing in relation to the operations as described herein. The encoding and decoding of video data streams, which includes compression of the data (such that the data can be stored and/or transmitted in smaller size data bit streams), can be in accordance with any suitable format utilized for video transmissions in collaboration sessions (e.g., H.264 format).

The codec module 16 includes a color histogram generation module 18 that generates color histograms for video frames that are received by the computing device and have been decoded. The color histograms that are generated by module 18 are analyzed by a histogram analysis/frame processing module 20 of the codec module 16 in order to process frames (e.g., rendering a frame, refining or filtering a frame, designating a frame as new, etc.) utilizing the techniques as described herein. While the codec module is generally depicted as being part of the memory of the computing device, it is noted that the codec module can be implemented in any other form within the computing device or, alternatively, as a separate component associated with the computing device. In addition, the codec module can be a single module or formed as a plurality of modules with any suitable number of applications that perform the functions of coding, decoding and analysis of coded frames based upon color histogram information utilizing the techniques described herein.

Each server device 6 can include the same or similar components as the computing devices 4 that engage in collaboration sessions. In addition, each server device 6 includes one or more suitable software modules (e.g., stored in memory) that are configured to facilitate a connection and transfer of data between multiple computing devices via the server device(s) during a collaboration or other type of communication session. Each server device 6 can also include a codec module for encoding and/or decoding of a data stream including video data and/or other forms of data (e.g., desktop sharing content) being exchanged between two or more computing devices during a collaboration session.

Some examples of types of computing devices that can be used in system 2 include, without limitation, stationary (e.g., desktop) computers, personal mobile computer devices such as laptops, note pads, tablets, personal data assistant (PDA) devices, and other portable media player devices, and cell phones (e.g., smartphones). The computing and server devices can utilize any suitable operating systems (e.g., Android, Windows, Mac OS, Symbian OS, RIM Blackberry OS, Linux, etc.) to facilitate operation, use and interaction of the devices with each other over the system network.

System operation, in which a collaboration session including content sharing is established between two or more computing devices, is now described with reference to the flowcharts of FIGS. 3-6. At 50, a collaboration session is initiated between two or more computing devices 4 over the system network, where the collaboration session is facilitated by one or more server device(s) 6. During the collaboration session, a computing device 4 shares its screen or desktop content (e.g., some or all of the screen content that is displayed by the sharing computing device) with other computing devices 4, where the shared content is communicated from the sharing device 4 to other devices 4 via any server device 6 that facilitates the collaboration session. At 60, a data stream associated with the shared screen content is encoded utilizing conventional or other suitable types of video encoder techniques (e.g., in accordance with H.264 standards). The data stream to be encoded can be of any selected or predetermined length. For example, when processing a continuous data stream, the data stream can be partitioned into smaller sets or packets of data, with each packet including a selected number of frames that are encoded. The encoding of the data can be performed utilizing the codec module 16 of the desktop sharing computing device 4 providing the content during the collaboration session and/or a codec module of one or more server devices 6.

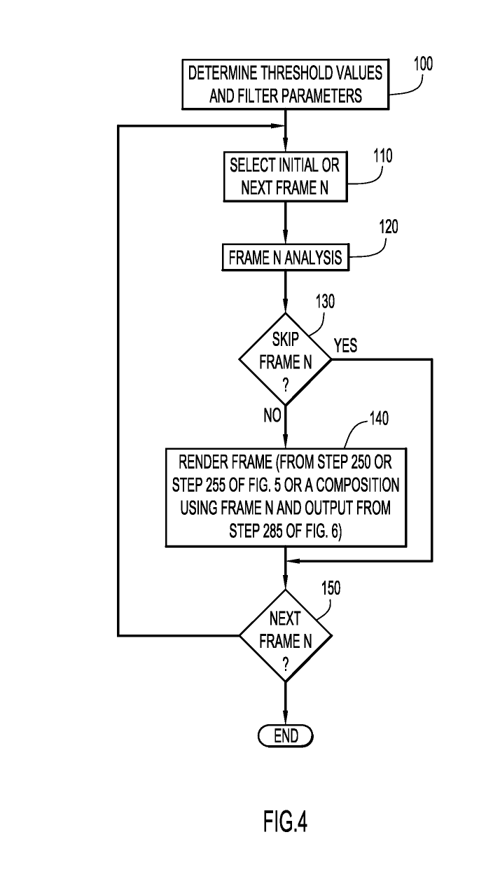

At 70, the encoded data stream is provided, via the network, to the other computing devices 4 engaged in the collaboration session. Each computing device 4 that receives the encoded data stream utilizes its codec module 16, at 80, to decode the data stream for use by the device 4, including display of the shared content via the display 9. The decoding of a data stream also utilizes conventional or other suitable video encoder techniques (e.g., utilizing H.264 standards). The use of decoded video frames for display is based upon an analysis of semantic and quality levels of the video frames according to the techniques as described herein in relation to FIGS. 4-6 and utilizing the codec module 16 of each computing device 4. The encoding of a data stream (e.g., in sets or packets) for transmission by the sharing device 4 and decoding of such data stream by the receiving device(s) continues until termination of the collaboration session at 90.

Received and decoded video content at a computing device 4 is processed to determine whether certain video frames, based upon content and quality of the video frames, are to be further processed (e.g., filtered or enhanced), rendered, or discarded. The processing of the video frames utilizes color histograms associated with the video frames to measure differences between frames in order to account for content changes as well as quality variations between frames.

An example embodiment of analyzing and further processing decoded video frames at a computing device 4 is now described with reference to FIGS. 4-6. Referring to FIG. 4, threshold values T are determined for analyzing differences in color histograms between video frames, and filter parameters for filtering certain video frames are set at 100. The filter parameters and threshold values can be set based upon noise levels and coding artifacts that may be known as typically present within a video stream for one or more collaboration sessions within the system 2 or in any other suitable manner.

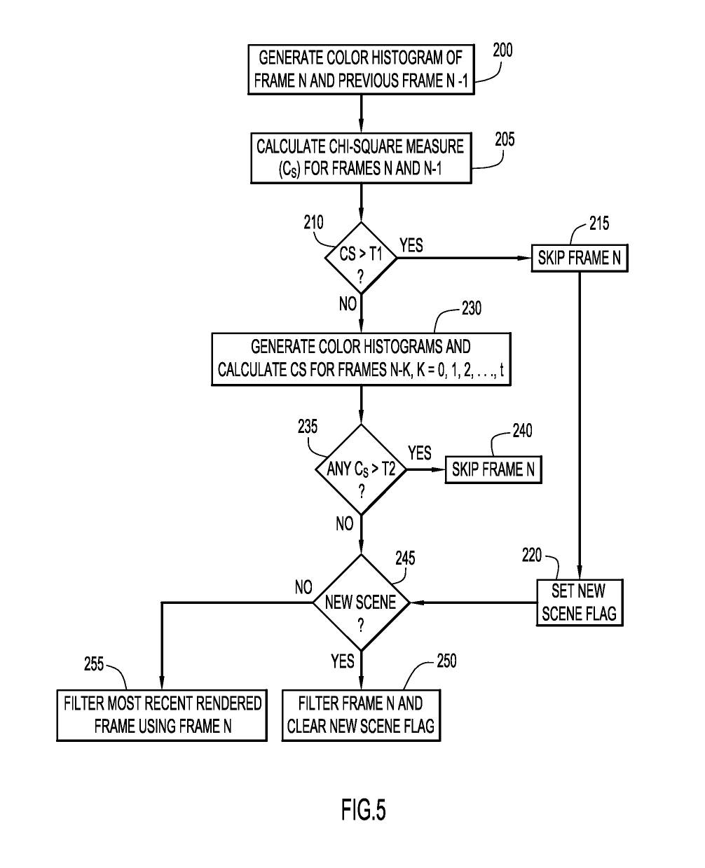

At 110, a video frame N from a series of already decoded video frames is selected for analysis. The video frame N is analyzed at 120. Analysis of the video frame, to determine whether it is to be rendered or skipped, is described by the steps set forth in FIG. 5. In particular, color histograms of frame N and another, previous frame (e.g., frame N−1) are generated at 200 utilizing the color histogram generator 18 of the codec module 16 for the computing device 4. The color histograms can be generated utilizing any suitable conventional or other technique that provides a suitable representation of the image based upon a distribution of the colors associated with the image.

At 205, a technique is performed to determine a difference between the color histograms for frame N and the previous frame (N−1). In an example embodiment, the technique utilizes a Chi-Square measure that calculates a bin-to-bin difference between the color histograms generated for frame N and the previous frame (N−1). Chi-Square algorithms are known for calculating differences between histograms. In addition, any suitable software algorithms may be utilized by the codec module 16, including the use of source code provided from any open source library (e.g OpenCV, http://docs.opencv.org/modules/imgproc/doc/histograms.html). The Chi-Square value obtained, C_{S}, is compared to a first threshold value T1 at 210 to determine whether the difference between the two video frames is so great as to indicate that frame N represents a new scene. For example, the previous video frames leading up to frame N may have represented a relatively static image within the collaboration session (e.g., a presenter was sharing content that included a document that remained on the same page or an image that was not changing and/or not moving). If the scene changes (e.g., new content is now being shared), the C_{S} value representing the difference between the color histogram of frame N and a previous frame (N−1) would be greater than the first threshold value T1. It is noted that the first threshold value T1, as well as other threshold values described herein, can be determined at the start of the process (at 100) and based upon user experience within a particular collaboration session and based upon a number of other factors or conditions associated with the system.

In response to the C_{S} value exceeding the first threshold value T1, frame N is skipped at 215 and a new scene flag indicator is set at 220 to indicate that a new scene (beginning with frame N) has occurred within the sequence of decoded video frames being analyzed. For example, the new scene flag indicator might be set from a value of zero (indicating no new scene) to a value of 1 (indicating a new scene). The new scene flag 220 is referenced again in relation to 245 as described herein.

In response to the C_{S} value not exceeding the first threshold value T1 (thus indicating that a new scene has not occurred), additional C_{S} values are calculated within a selected time window t at 230. This analysis is performed to determine whether the quality of frame N is such that it can be rendered or, alternatively, it should be skipped. In particular, color histograms are generated for frames N−K, where K=0, 1, 2 . . . t, and C_{S} values are determined for each comparison between frame N and frame N−K. At 235, in response to any C_{S} value over the range of frames N−K exceeding a second threshold value T2, a decision is made to skip frame N at 240.

In response to a determination that each C_{S} value is not greater than the second threshold value T2, a determination is made at 245 whether frame N represents a new scene. This is based upon whether the new scene flag indicator has been set (at 220) to an indication that a new scene has occurred (e.g., new scene flag indicator set to 1) from a previous frame (e.g., frame N−1). In response to an indication that a new scene has occurred, frame N is filtered at 250 to reduce noise and to provide smoothing, sharpening, or other enhancing effects for the image. An example filtering that is utilized is a spatial filter, such as an edge enhancement or sharpen filter or a spacial bilateral filter that removes noise while preserves edges in the image, applied to the frame N. The new scene flag indicator is also cleared (e.g., set to a zero value).

In response to a determination that a new scene has not occurred (e.g., new scene flag has a zero value), the most recently rendered frame can be filtered at 255 utilizing frame N and a temporal filter or a spatio-temporal filter. The temporal or spatio-temporal filtering can be applied to reduce or remove possible noise and/or coding artifacts in the most recently rendered frame using frame N as a temporal reference. An example filtering is a spatio-temporal bilateral filter that applies bilateral filtering to each pixel in the most recently rendered frame using neighboring pixels from both the most recently rendered frame and frame N, the temporal reference. The term filtering can further be generalized to include superimposing a portion of the content of the current frame N into the most recently rendered frame and possibly replacing some or all of the most recently rendered frame with content from the current frame N. In an example embodiment, a further threshold value can be utilized to determine whether the most recently rendered frame will be entirely replaced with frame N at 255. A bin-to-bin difference measure or a cross bin difference measure can be utilized for the color histograms associated with the most recently rendered frame and frame N, and in response to this measured value exceeding a threshold value frame N will replace the most recently rendered frame entirely (i.e., frame N will be rendered instead of any portion of the most recently rendered frame).

Referring again to FIG. 4, after frame analysis has occurred (utilizing the techniques as described in relation to the flowchart of FIG. 5), if the frame N is to be skipped the process proceeds to 150 in which it is determined whether another frame N (i.e., the next frame, or frame N+1 in relation to the current frame N) is to be analyzed. If it has been determined to not skip frame N, the filtered frame N or a previously rendered frame that is filtered utilizing frame N is rendered for display at 140 by the display 9 of the computing device 4 (e.g., step 250 or step 255, based upon the new scene flag indicator). In particular, at 140, a frame is rendered for display that may be frame N (filtered to improve the quality of frame N, based upon step 250) or a most recently rendered frame that is filtered using frame N (based upon step 255). At 150, a determination is made whether another frame is to be analyzed (i.e., the next frame, or frame N+1). In response to a determination that another frame N is to be analyzed, the next frame N is selected at 110 and the process is repeated.

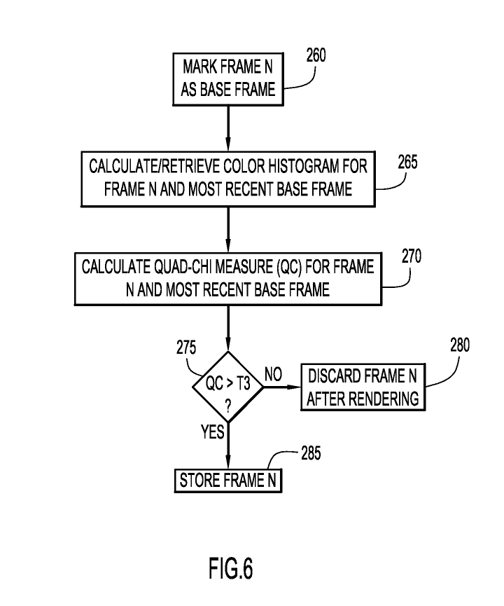

In a modified embodiment, a frame N that is filtered at 250 is further processed according to the technique as set forth in FIG. 6 to determine whether frame N should be selected as a base frame. A base frame is a candidate for a semantic frame for rendering frames based upon a certain quality level or other characteristic of the frame. One or more base frames can be determined initially within the decoding process. The determination of whether a current frame N will also be stored as a base frame can be based upon comparison with at least one other base frame. In particular, the filtered frame N resulting from 250 is marked as a base frame at 260. At 265, color histograms are calculated or retrieved for frame N and the most recent base frame. At 270, a cross bin difference measure, such as a Quad-Chi measure, QC, of the color histograms of the two frames (frame N and the most recent base frame) is calculated. A detailed explanation of the Quad-Chi measure is described, e.g., by Ofir Pele and Michael Werman (The Quadradic-Chi Histogram Distance Family, School of Computer Science, The Hebrew University of Jerusalem, http://www.cs.huji.ac.il/˜ofirpele/QC/), the disclosure of which is incorporated herein by reference in its entirety. At 275, the QC value obtained from step 270 is compared with a third threshold value, T3. In the event the QC value does not exceed the third threshold value T3, frame N is discarded after being rendered at 280. In the event the QC value exceeds the third threshold value T3, frame N is stored as a semantic frame at 285. Further, a previously rendered and stored semantic frame from 285 can be composed with a filtered frame N resulting from 250 or 255 to form a composed frame (e.g., the composed frame comprises a merging of some of the content from frame N into the previously rendered frame), where the composed frame is rendered at 140 in FIG. 4.

Thus, the techniques described herein facilitate the improvement of video content displayed at a receiving computing device during a collaboration session, where video frames are decoded and rendered for display based upon the criteria as described herein (where a current frame N is analyzed and either skipped, filtered and rendered or combined with a previously rendered frame and rendered). A plurality of comparison techniques for color histograms of video frames (such as Chi-Square bin-to-bin measurements and Quad-Chi cross bin measurements) can be used to determine content changes and quality changes associated with a current frame N and previous frames, while a plurality of filtering techniques (e.g., spatial bilateral filtering and spatial-temporal bilateral filtering) can also be used to enhance the quality and reduce or eliminate coding artifacts within video frames rendered for display. The Chi-Square measurements provide a good indication for both content and quality changes between video frames, while Quad-Chi measurements provide a strong indication for content changes. By combining the two types of measurements as described herein, the techniques facilitate both accurate and efficient detection of content and quality changes as well as being able to differentiate between the two types of changes (e.g., so as to accurately confirm whether a scene change has occurred).

In addition, due to different receiving conditions and different user endpoint configurations (e.g., different filter conditions, different threshold values being set for color histogram comparisons, etc.), users at different receiving endpoint computing devices may observe different sequences of rendered frames. Due to possibly different receiving conditions and different user configurations, content will be rendered with certain spatial and temporal disparities to improve perceptual quality, respectively. However, the semantics of a presenter's content within a collaboration session will be preserved, and the overall collaboration experience will be enhanced utilizing the techniques described herein.

The above description is intended by way of example only.

What is claimed is:

1. A method comprising:
receiving and decoding a sequence of video frames at a computing device; and
analyzing, by the computing device, a current video frame N to determine whether to skip or render the current video frame N for display by the computing device, the analyzing comprising:
generating color histograms of the current video frame N and one or more previous video frames;
determining a difference value representing a difference between the current video frame N and a previous video frame N−K, wherein K>0, the difference value being based upon the generated color histograms;
in response to the difference value not exceeding a threshold value, rendering the current video frame N or a recently rendered video frame N−K using the current video frame; and
in response to the difference value exceeding the threshold value, skipping the current video frame N from being rendered.

2. The method of claim 1, wherein the analyzing by the computing device further comprises:
determining, based upon the difference value being compared with a first threshold value, whether a difference between the current video frame N and a previous video frame N−K indicates a change in content between the current video frame N and the previous video frame N−K; and
in response to the difference value exceeding the first threshold value, skipping the current video frame N from being rendered and setting a scene indicator to a value that indicates a change in scene has occurred from the previous video frame N−K to the current video frame N.

3. The method of claim 2, wherein the determining the difference value further comprises:
obtaining a Chi-Square measure that calculates a bin-to-bin difference between color histograms generated for the current video frame N and the previous video frame N−K.

4. The method of claim 2, wherein the analyzing by the computing device further comprises, in response to the difference value not exceeding the first threshold value:
generating color histograms of the current video frame N and a plurality of previous video frames N−K, wherein K=1 to t and t represents a number of video frames within a predetermined time window;
determining a plurality of second difference values, each second different value representing a difference between the generated color histogram of the current video frame N and the generated color histogram of a previous video frame N−K of the plurality of previous video frames N−K;
determining, based upon each second difference value being compared with a second threshold value, whether a difference between the current video frame N and at least one previous video frame N−K of the plurality of previous video frames N−K indicates a change in a quality level between the current video frame N and the plurality of previous video frames N−K; and
in response to any second difference value exceeding the second threshold value, skipping the current video frame N from being rendered.

5. The method of claim 4, wherein, in response to no second difference value exceeding the second threshold value:
filtering video frame N and changing the scene indicator to have a value indicating no scene change has occurred in response to the scene indicator having a current value that indicates a change in scene has occurred.

6. The method of claim 4, wherein, in response to no second difference value exceeding the second threshold value:
filtering a most recent rendered video frame N−K utilizing frame N in response to the scene indicator indicating no scene change has occurred.

7. The method of claim 4, wherein the sequence of video frames includes at least one base video frame that provides semantic analysis for the sequence of video frames and, in response to no second difference value exceeding the second threshold value:
obtaining color histograms of the current video frame N and a previous base video frame;
obtaining a third difference value comprising a Quad-Chi measure that calculates a bin-to-bin difference between color histograms obtained for the current video frame N and the previous base video frame; and
in response to the third difference value not exceeding a third threshold value, storing in a memory frame N as a base frame.

8. The method of claim 1, further comprising:
engaging in a video collaboration session between the computing device and a second computing device, wherein the computing device receives the sequence of video frames from the video collaboration session for decoding and rendering via a display of the computing device.

9. An apparatus comprising:
a memory configured to store instructions including one or more software applications; and
a processor configured to execute and control operations of the one or more software applications so as to:
receive and decode a sequence of video frames at a computing device; and
analyze a current video frame N to determine whether to skip or render the current video frame N for display by the computing device, by:
generating color histograms of the current video frame N and one or more previous video frames;
determining a difference value representing a difference between the current video frame N and a previous video frame N−K, wherein K>0, the difference value being based upon the generated color histograms;
in response to the difference value not exceeding a threshold value, rendering the current video frame N or a recently rendered video frame N−K using the current video frame; and
in response to the difference value exceeding the threshold value, skipping the current video frame N from being rendered.

10. The apparatus of claim 9, wherein the processor is further configured to analyze the current video frame N by:
determining, based upon the difference value being compared with a first threshold value, whether a difference between the current video frame N and a previous video frame N−K indicates a change in content between the current video frame N and the previous video frame N−K; and
in response to the difference value exceeding the first threshold value, skipping the current video frame N from being rendered and setting a scene indicator to a value that indicates a change in scene has occurred from the previous video frame N−K to the current video frame N.

11. The apparatus of claim 10, wherein the processor is configured to determine the difference value by:
obtaining a Chi-Square measure that calculates a bin-to-bin difference between color histograms generated for the current video frame N and the previous video frame N−K.

12. The apparatus of claim 10, wherein the processor is further configured to analyze the current video frame N, in response to the difference value not exceeding the first threshold value, by:
generating color histograms of the current video frame N and a plurality of previous video frames N−K, wherein K=1 to t and t represents a number of video frames within a predetermined time window;
determining a plurality of second difference values, each second different value representing a difference between the generated color histogram of the current video frame N and the generated color histogram of a previous video frame N−K of the plurality of previous video frames N−K;
determining, based upon each second difference value being compared with a second threshold value, whether a difference between the current video frame N and at least one previous video frame N−K of the plurality of previous video frames N−K indicates a change in a quality level between the current video frame N and the plurality of previous video frames N−K; and
in response to any second difference value exceeding the second threshold value, skipping the current video frame N from being rendered.

13. The apparatus of claim 12, wherein the processor is configured to, in response to no second difference value exceeding the second threshold value:
filter video frame N and change the scene indicator to have a value indicating no scene change has occurred in response to the scene indicator having a current value that indicates a change in scene has occurred.

14. The apparatus of claim 12, wherein the processor is configured to, in response to no second difference value exceeding the second threshold value:
filter a most recent rendered video frame N−K utilizing frame N in response to the scene indicator indicating no scene change has occurred.

15. The apparatus of claim 12, wherein the processor is configured to determine at least one base video frame from the sequence of video frames, each base frame providing semantic analysis for the sequence of video frames, and the processor is further configured to, in response to no second difference value exceeding the second threshold value:
obtain color histograms of the current video frame N and a previous base video frame;
obtain a third difference value comprising a Quad-Chi measure that calculates a bin-to-bin difference between color histograms obtained for the current video frame N and the previous base video frame; and
in response to the third difference value not exceeding a third threshold value, store in the memory the frame N as a base frame.

16. The apparatus of claim 9, further comprising:
a display;
a network interface device configured to enable communications over a network;
wherein the processor is further configured to engage the apparatus in a video collaboration session with at least another computing device that facilitates the apparatus receiving the sequence of video frames from the video collaboration session for decoding and rendering via the display of the apparatus.

17. One or more computer readable storage media encoded with software comprising computer executable instructions and when the software is executed operable to:
receive and decode a sequence of video frames at a computing device; and
analyze, by the computing device, a current video frame N to determine whether to skip or render the current video frame N for display by the computing device, by:
generating color histograms of the current video frame N and one or more previous video frames;
determining a difference value representing a difference between the current video frame N and a previous video frame N−K, wherein K>0, the difference value being based upon the generated color histograms;
in response to the difference value not exceeding a threshold value, rendering the current video frame N or a recently rendered video frame N−K using the current video frame; and
in response to the difference value exceeding the threshold value, skipping the current video frame N from being rendered.

18. The computer readable storage media of claim 17, wherein the instructions are operable to analyze the current video frame N by:
determining, based upon the difference value being compared with a first threshold value, whether a difference between the current video frame N and a previous video frame N−K indicates a change in content between the current video frame N and the previous video frame N−K; and
in response to the difference value exceeding the first threshold value, skipping the current video frame N from being rendered and setting a scene indicator to a value that indicates a change in scene has occurred from the previous video frame N−K to the current video frame N.

19. The computer readable storage media of claim 18, wherein the instructions are operable to determine the difference value by:
obtaining a Chi-Square measure that calculates a bin-to-bin difference between color histograms generated for the current video frame N and the previous video frame N−K.

20. The computer readable storage media of claim 18, wherein the instructions are operable to further analyze the current video frame N, in response to the difference value not exceeding the first threshold value, by:
generating color histograms of the current video frame N and a plurality of previous video frames N−K, wherein K=1 to t and t represents a number of video frames within a predetermined time window;
determining a plurality of second difference values, each second different value representing a difference between the generated color histogram of the current video frame N and the generated color histogram of a previous video frame N−K of the plurality of previous video frames N−K;
determining, based upon each second difference value being compared with a second threshold value, whether a difference between the current video frame N and at least one previous video frame N−K of the plurality of previous video frames N−K indicates a change in a quality level between the current video frame N and the plurality of previous video frames N−K; and
in response to any second difference value exceeding the second threshold value, skipping the current video frame N from being rendered.

21. The computer readable storage media of claim 20, wherein the instructions are operable to, in response to no second difference value exceeding the second threshold value:
filter video frame N and changing the scene indicator to have a value indicating no scene change has occurred in response to the scene indicator having a current value that indicates a change in scene has occurred.

22. The computer readable storage media of claim 20, wherein the instructions are operable to, in response to no second difference value exceeding the second threshold value:
filter a most recent rendered video frame N−K utilizing frame N in response to the scene indicator indicating no scene change has occurred.

23. The computer readable storage media of claim 20, wherein the instructions are operable to determine at least one base video frame from the sequence of video frames, each base frame providing semantic analysis for the sequence of video frames, and the instructions are further operable to, in response to no second difference value exceeding the second threshold value:
obtain color histograms of the current video frame N and a previous base video frame;
obtaining a third difference value comprising a Quad-Chi measure that calculates a bin-to-bin difference between color histograms obtained for the current video frame N and the previous base video frame; and
in response to the third difference value not exceeding a third threshold value, store in a memory frame N as a base frame.

24. The computer readable storage media of claim 17, wherein the instructions are operable to:
engage in a video collaboration session between a first computing device and a second computing device, wherein the first computing device receives the sequence of video frames from the video collaboration session for decoding and rendering via a display of the first computing device.
